(19) United States
(12) Patent Application Publication
(10) Pub. No.: US 2011/0137510 A1
(43) Pub. Date: Jun. 9, 2011

(54) COMMUNICATION INTERFACE CONVERSION DEVICE

(76) Inventors: Yi-Yang TSAI, Kaohsiung City (TW); Qin-Sheng HUANG, Kaohsiung City (TW)

(21) Appl. No.: 12/960,132

(22) Filed: Dec. 3, 2010

(30) Foreign Application Priority Data
Dec. 4, 2009 (TW) 098141524

(51) Int. Cl. G06F 19/00; H04B 1/38

(52) U.S. Cl. 701/29; 375/220

(57) ABSTRACT

A communication interface conversion device is suitable for electrically connecting a detecting unit and a vehicle electronic control unit (ECU) with different communication interfaces. The communication interface conversion device includes a first circuitry, a second circuitry, and a conversion module. The conversion module has a first transceiver unit, a second transceiver unit, an oscillation circuit, a resetting circuit, and a chip unit electrically connected with the first transceiver unit, the second transceiver unit, the oscillation circuit, and the resetting circuit. The first and second transceivers and the chip unit are used to perform data conversion, so that a first signal of the ECU and a second signal of the detecting unit which are of different communication interfaces can be transmitted, thereby improving generality thereof.

### CROSS-REFERENCE TO RELATED APPLICATION

This application claims the benefit of Taiwan Patent Application No. 098141524, filed on Dec. 4, 2009, which is hereby incorporated by reference for all purposes as if fully set forth herein.

### BACKGROUND OF THE INVENTION

1. Field of Invention

The present invention relates to a conversion device, and in particular, to a communication interface conversion device.

2. Related Art

As an electronic control technology of a vehicle is widely used, vehicle electronic control units (ECUs) and electronic components are widely developed, for example, an automatic transmission, antilock brake system (ABS), global positioning system (GPS), and lighting control system. Communication data of the control systems is shared. If a conventional wiring method is adopted, the number of wires in a car inevitably will increase rapidly. In this case, many in-car electronic and communication interfaces are developed, among which a local interconnect network (LIN), K-Line, controller area network (CAN), FlexRay, TIP/C, SAEJ1850, TFCAN, automotive safety restraints bus (ASRB), MOST, and others are common, and the K-Line and CAN communication interfaces are applied to a motorcycle.

FIG. 1 is an ECU 12 (such as an ECU), which uses the K-Line as the communication interface. When a state of the ECU 12 is diagnosed, a diagnostor 11 with the K-Line communication interface is electrically connected with the ECU 12 via a K-Line line 13, so as to achieve an effect of data transmission. Since the K-Line communication interface performs signal transmission via a single circuitry, the K-Line communication interface merely can be individually connected with one ECU instead of simultaneously reading data of multiple ECUs.

The CAN communication interface developed later is connected to a network via a twisted pair, so as to connect multiple ECUs. As shown in FIG. 2, the CAN performs differential voltage transmission via double copper twisted wires of CAN-H and CAN-L, and is electrically connected to a meter board 14 and an ECU 15 of the same CAN communication interface. Thus, a personal computer 16 reads data of the multiple ECUs, so as to achieve the effect of synchronized diagnosis.

However, the communication interfaces of current motorcycle ECUs still include the K-Line communication interface and the CAN communication interface, and the diagnostors corresponding to the two communication interfaces are not interchangeable because of the incompatibility of the signal transmission manners. As a result, a user has to be equipped with a diagnostor with the two different communication interfaces of K-Line and CAN, so as to diagnose the motorcycle ECUs with the two different communication interfaces. Troubles of measurement and diagnosis for the user are increased, and acquisition cost is also raised because of the equipment of different diagnostors.

### SUMMARY OF THE INVENTION

Accordingly, the present invention is directed to a communication interface conversion device, which can be used in different interfaces.

The present invention is also directed to a signal conversion method of a communication interface conversion device, which can reduce cost for purchasing additional detecting units.

The communication interface conversion device of the present invention is suitable for electrically connecting a detecting unit and a vehicle ECU with different communication interfaces. The communication interface conversion device comprises a first circuitry, a second circuitry, and a conversion module.

The first circuitry is electrically connected with the vehicle ECU, and is used to transfer a first signal of the ECU. The second circuitry is electrically connected with the detecting unit, and is used to transfer a second signal of the detecting unit.

The conversion module comprises a first transceiver unit electrically connected with the first circuitry, a chip unit electrically connected with the first transceiver unit, a resetting circuit that is electrically connected with the chip unit and enables the chip unit to be reset, an oscillation circuit electrically connected with the chip unit, and a second transceiver unit electrically connected with the chip unit. The oscillation circuit is capable of transferring a reference frequency to the chip unit, so as to stabilize an operating frequency of the chip unit, and the first signal and the second signal may be converted into each other by using the first transceiver unit, the second transceiver unit, and the chip unit.

The signal conversion method of the communication interface conversion device of the present invention comprises an instruction setting step, a first conversion step, a transferred data conversion step, a second conversion step, a reply processing step, a third conversion step, a received data conversion step, and a fourth conversion step.

In the instruction setting step, a detecting unit sets a transfer instruction, and transfers a second signal to a second transceiver unit of a conversion module via a second circuitry.

In the first conversion step, the second transceiver unit of the conversion module performs electronic signal conversion on the received second signal, and then transfers the converted second signal to a chip unit.

In the transferred data conversion step, the chip unit of the conversion module converts the received second signal into relay data, sets a frequency and a sampling rate of the relay data, converts the transfer instruction thereof into a reception instruction readable to an ECU, so as to convert the relay data into a first signal and then transfer the first signal to the first transceiver unit.

In the second conversion step, the first transceiver unit of the conversion module performs electronic signal conversion on the received first signal, and then transfers the converted first signal to the ECU.

In the reply processing step, the ECU receives the first signal and reads the transfer instruction thereof, and then replies with another first signal to the first transceiver unit via the first circuitry.

In the third conversion step, the first transceiver unit of the conversion module performs electronic signal conversion on the received first signal, and then transfers the converted first signal to the chip unit.

In the received data conversion step, the chip unit converts the received first signal into relay data, and compares the frequency and the sampling rate of the relay data, so as to convert the relay data into a second signal and transfer the second signal to the second transceiver unit.

In the fourth conversion step, the second transceiver unit of the conversion module performs electronic signal conversion on the received second signal, and then transfers the converted second signal to the detecting unit.

The efficacy of the present invention lies in that, the first transceiver unit, the second transceiver unit, and the chip unit are capable of converting the first signal of the ECU and the second signal of the detecting unit into each other, so that the ECU and detecting unit of different communication interfaces may perform signal transmission. Thus, the generality is improved, and the acquisition cost can be effectively reduced by avoiding additionally equipping with different detecting units.

### BRIEF DESCRIPTION OF THE DRAWINGS

The present invention will become more fully understood from the detailed description given herein below for illustration only, and thus are not limitative of the present invention, and wherein:

FIG. 1 is a block diagram for illustrating a connection aspect of a conventional K-Line communication interface;

FIG. 2 is a block diagram for illustrating a connection aspect of a conventional CAN communication interface;

FIG. 3 is a block diagram for illustrating a first preferred embodiment of a communication interface conversion device according to the present invention;

FIG. 4 is a circuit diagram for illustrating a circuit connection aspect of the first preferred embodiment;

FIG. 5 is a flow chart of a preferred embodiment of a signal conversion method of a communication interface conversion device according to the present invention;

FIG. 6 is a block diagram of a second preferred embodiment for illustrating a communication interface conversion device according to the present invention;

FIG. 7 is a block diagram for illustrating a third preferred embodiment of a communication interface conversion device according to the present invention; and

FIG. 8 is a block diagram for illustrating a fourth preferred embodiment of a communication interface conversion device according to the present invention.

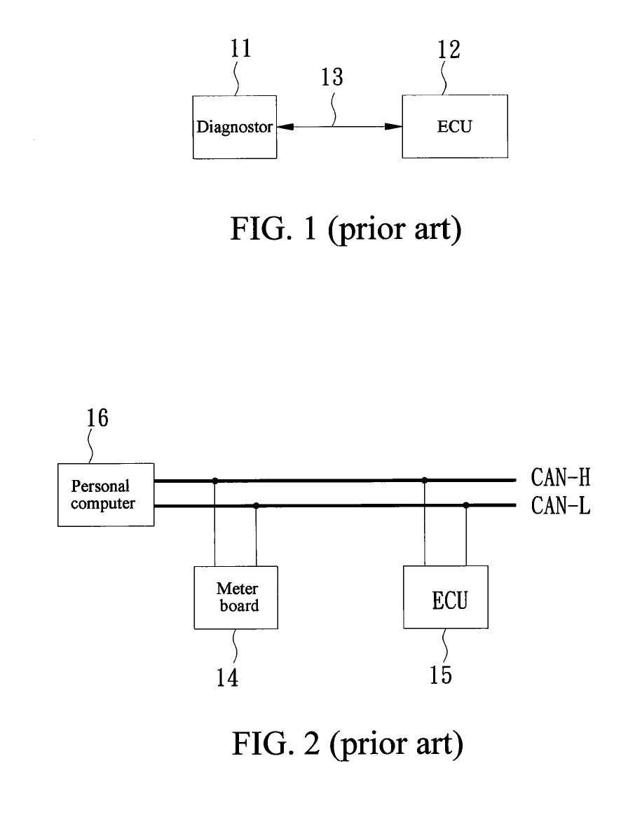

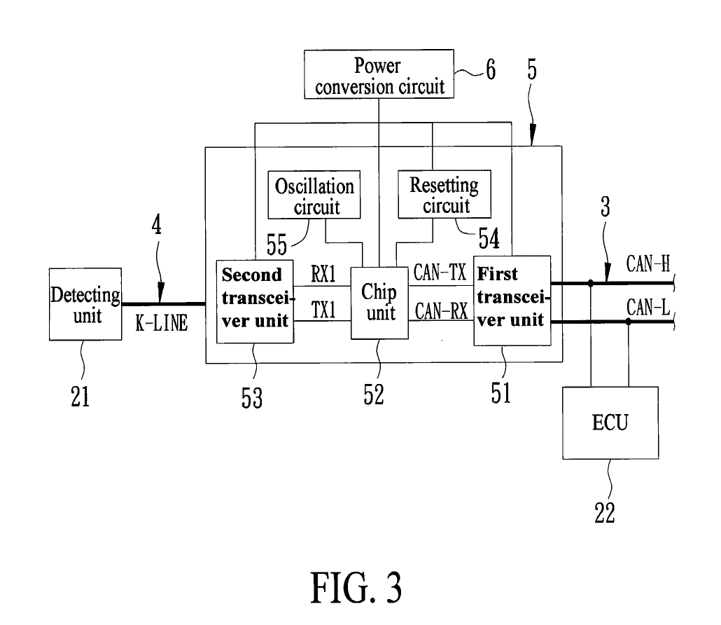

### DETAILED DESCRIPTION OF THE INVENTION

The abovementioned and other technical contents, features, and efficacies of the present invention will be clearly presented in detailed descriptions of the four preferred embodiments with reference to the drawings.

Before the present invention is described in detail, it should be noted that similar elements in the following descriptions are represented by the same numbers.

FIG. 3 is a first preferred embodiment of a communication interface conversion device according to the present invention. The communication interface conversion device is suitable for electrically connecting a detecting unit 21 and a vehicle ECU 22 with different communication interfaces. The detecting unit 21 is used to display a data signal transferred by the vehicle ECU 22, so as to diagnose and analyze the ECU 22. In this embodiment, the detecting unit 21 is a portable diagnostor, and the ECU 22 may be an electronic component such as a vehicle ECU and a meter board, but is not limited to. Since a structure of the detecting unit 21 and a structure of the ECU 22 are known to persons of ordinary skill in the art, descriptions of the structures are not given herein.

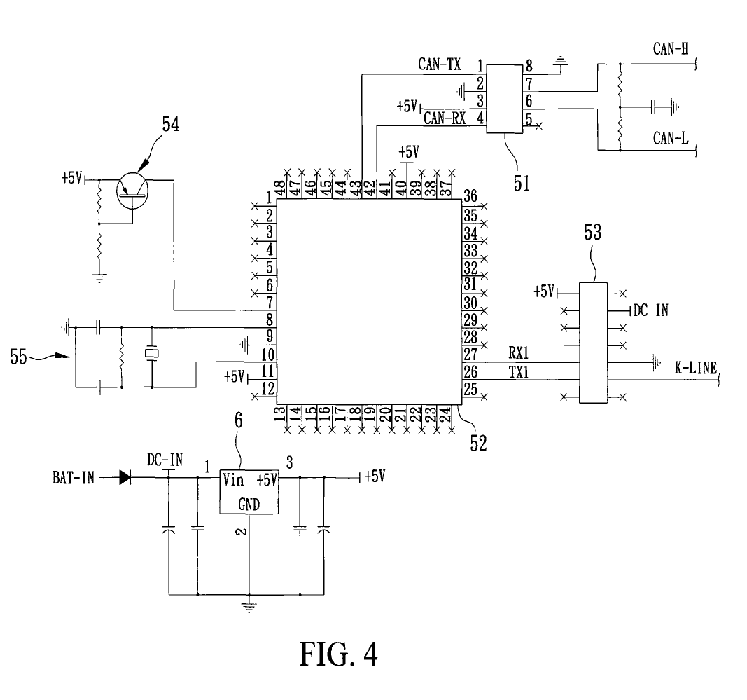

As shown in FIG. 3 and FIG. 4, the ECU 22 is a CAN communication interface, and the detecting unit 21 is a K-Line communication interface. The communication interface conversion device includes a first circuitry 3, a second circuitry 4, a conversion module 5, and a power conversion circuit 6. The power conversion circuit 6 is used to supply power to the conversion module 5.

The first circuitry 3 is a CAN communication interface with double copper twisted wires (CAN-H and CAN-L), and is electrically connected with the vehicle ECU 22. The second circuitry 4 is a K-Line communication interface with a single circuitry, and is electrically connected with the detecting unit 21. The first circuitry 3 is used to transfer a first signal of the ECU 22, and the second circuitry 4 is used to transfer a second signal of the detecting unit 21. In this embodiment, the first signal complies with an ISO11898 communication protocol, and the second signal complies with an ISO14230 communication protocol.

The conversion module 5 includes a first transceiver unit 51 electrically connected with the first circuitry 3, a chip unit 52 electrically connected with the first transceiver unit 51, a resetting circuit 54 that is electrically connected with the chip unit 52 and enables the chip unit to be reset, an oscillation circuit 55 electrically connected with the chip unit 52, and a second transceiver unit 53 electrically connected with the chip unit 52. The oscillation circuit 55 is capable of transferring a reference frequency to the chip unit 52, so as to stabilize an operating frequency of the chip unit 52. The power conversion circuit 6 is electrically connected with the first transceiver unit 51, the chip unit 52, the second transceiver unit 53, and the resetting circuit 54. The chip unit 52 and the first transceiver unit 51 perform data transmission via two circuitries of CAN-TX and CAN-RX, which may transmit the first signal of the ISO11898 communication protocol to each other. The chip unit 52 and the second transceiver unit 53 perform data transmission via two circuitries of RX1 and TX1, which may transmit the second signal of the ISO14230 communication protocol to each other.

During actual implementation, the detecting unit 21 sets an instruction and sends the second signal of the ISO14230 communication protocol. The second transceiver unit 53 transfers the second signal to the chip unit 52. The chip unit 52 converts the second signal into relay data of the ISO15765 communication protocol, then sets a frequency and a sampling rate, and converts it into the first signal of the ISO11898 communication protocol. The first transceiver unit 51 then transfers the first signal to the ECU 22.

Then, the ECU 22 replies with another first signal, and the first transmit-receive unit 51 transfers the first signal to the chip unit 52. The chip unit 52 converts the first signal into relay data, compares the frequency and the sampling rate, and then converts the relay data into the second signal. Finally, the second transceiver unit 53 transfers the second signal to the detecting unit 21, and displays data of the ECU 22.

As mentioned above, the first signal and the second signal can be converted into each other by using the first transceiver unit 51, the chip unit 52, and the second transceiver unit 53 of the conversion module 5, so that the ECU 22 of the CAN communication interface and the detecting unit 21 of the K-Line communication interface may perform signal transmission. Thus, cost for acquiring a detecting unit of another communication interface is reduced, and the generality of the communication interface conversion device of the present invention is improved.

In addition, since the chip unit 52 is electrically connected with the oscillation circuit 54, the reference frequency generated by the oscillation circuit 54 is taken as a reference value of the operating frequency of the chip unit 52, so as to improve accuracy of the operating frequency of the chip unit 52.

Further, when the chip unit 52 self-detects that the operation thereof is abnormal (for example, an executed program generates an infinite loop), the chip unit 52 may transfer a resetting signal to the resetting circuit 54 to enable the resetting circuit 54 to perform a resetting action on the chip unit 52, so as to enable the chip unit 52 to re-operate and maintain a steady operating state.

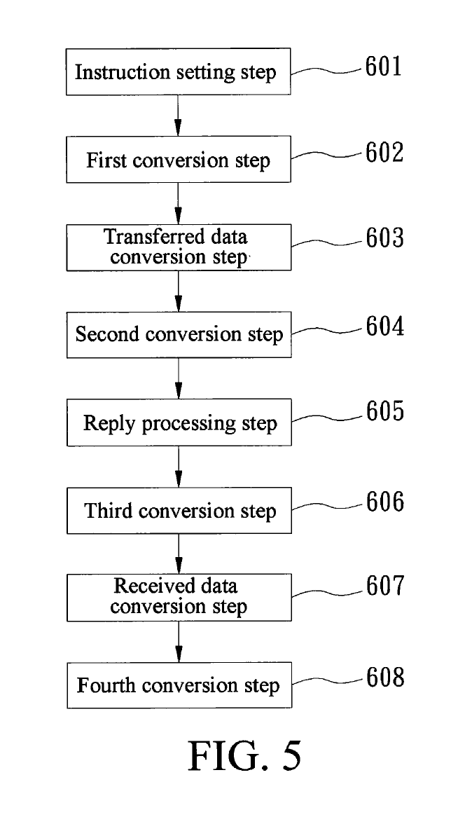

As shown in FIG. 3 and FIG. 5, a signal conversion method is performed based on the communication interface conversion device of the first preferred embodiment. The signal conversion method includes an instruction setting step 601, a first conversion step 602, a transferred data conversion step 603, a second conversion step 604, a reply processing step 605, a third conversion step 606, a received data conversion step 607, and a fourth conversion step 608.

In the instruction setting step 601, the detecting unit 21 sets a transfer instruction, and transfers the second signal generated by the detecting unit 21 to the second transceiver unit 53 of the conversion module 5 via a second circuitry 4. In this embodiment, the second signal complies with the ISO14230 communication protocol, and is used to enable the second transceiver unit 53 to transfer the signal between the detecting unit 21 and the chip unit 52.

In the first conversion step 602, the second transceiver unit 53 of the conversion module 5 performs electronic signal conversion on the received second signal, adjusts an amplitude of the second signal, and transfers the second signal to the chip unit 52, so as to enable the chip unit 52 to read the second signal.

In the transferred data conversion step 603, the chip unit 52 of the conversion module 5 converts the received second signal into relay data, sets a frequency and a sampling rate of the relay data, converts the transfer instruction set by the detecting unit 21 into a reception instruction readable to the ECU 22, so as to convert the relay data into a first signal and transmit the first signal to the first transceiver unit 51. In this embodiment, the relay data complies with the ISO15765 communication protocol, and the first signal complies with the ISO11898 communication protocol.

In the second conversion step 604, the first transceiver unit 51 of the conversion module 5 performs electronic signal conversion on the received first signal, adjusts an amplitude of the first signal, and transfers the first signal to the ECU 22, so as to enable the ECU 22 to read the second signal.

In the reply processing step 605, the ECU 22 receives the first signal and reads the converted transfer instruction, and performs an action according to the transfer instruction. Then, the ECU 22 replies with another first signal, and transfers the first signal to the first transceiver unit 51 via the first circuitry 3.

In the third conversion step 606, the first transceiver unit 51 of the conversion module 5 performs electronic signal conversion on the received first signal, adjusts the amplitude of the first signal, and transfers the first signal to the chip unit 52, so as to enable the chip unit 52 to read the first signal.

In the received data conversion step 607, the chip unit 52 converts the received first signal into relay data, and compares the frequency and the sampling rate of the relay data, so as to convert the relay data into the second signal and transfer the second signal to the second transceiver unit 53.

In the fourth conversion step 608, the second transceiver unit 53 of the conversion module 5 performs electronic signal conversion on the received second signal, adjusts the amplitude of the second signal, and transfers the second signal to the detecting unit 21, so as to enable the detecting unit 21 to read the first signal. Finally, the detecting unit 21 decodes and interprets the first signal, so as to display the data transferred by the ECU 22.

In the signal conversion method based on the communication interface conversion device of the present invention, the signal can be transferred and received between the detecting unit 21 of the K-line communication interface and the ECU 22, so that the cost for acquiring additional communication interface is reduced.

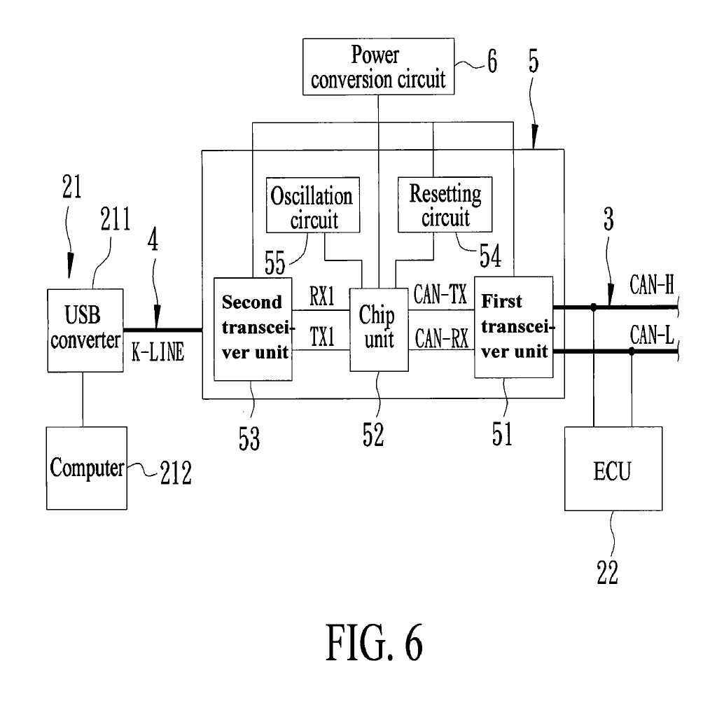

FIG. 6 is a second preferred embodiment of the communication interface conversion device according to the present invention. The second preferred embodiment is substantially the same as the first preferred embodiment, and differences lie in that, the detecting unit 21 has a universal serial bus (USB) converter 211 of the K-line communication interface and a computer 212 electrically connected with the USB converter 211. The USB converter 211 is electrically connected with the second circuitry 4, and is used to transfer the second signal of the ISO14230 communication protocol. Therefore, with the externally connected USB converter 211, the signal can be transferred and received between the computer 212 and the ECU 22, so as to improve the generality of the communication interface conversion device of the present invention.

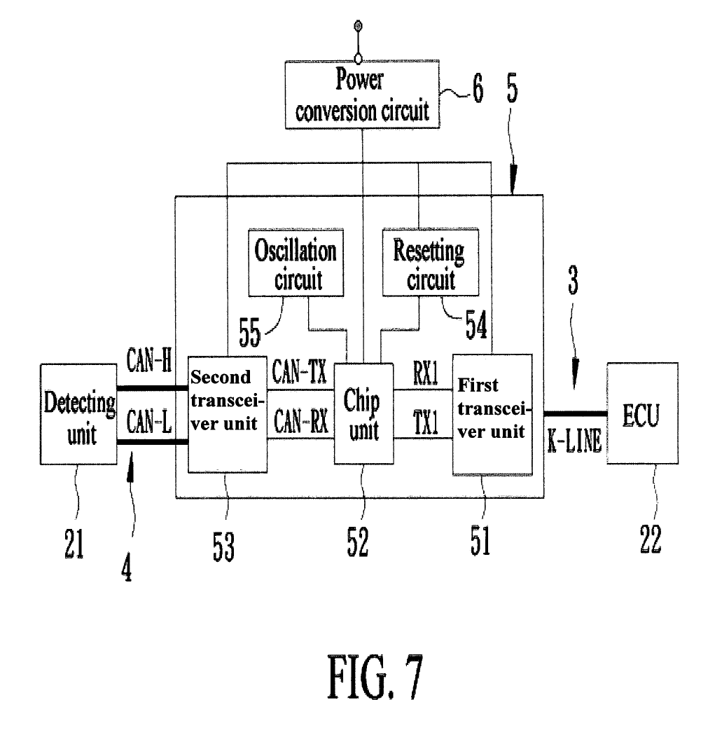

FIG. 7 is a third preferred embodiment of the communication interface conversion device according to the present invention. The third preferred embodiment is substantially the same as the first preferred embodiment, and differences lie in that, the first circuitry 3 is the K-Line communication interface, the second circuitry 4 is the CAN communication interface, the first signal complies with the ISO14230 communication protocol, the first transceiver unit 51 may perform electronic signal conversion on the first signal, so as to enable the chip unit 52 to interpret the first signal, the second signal complies with the ISO11898 communication protocol, the second transceiver unit 53 may perform electronic signal conversion on the second signal, so as to enable the chip unit 52 to interpret the second signal, and the chip unit 52 is capable of converting the first signal of the ISO14230 communication protocol and the second signal of the ISO11898 communication protocol into each other.

In this embodiment, the detecting unit 21 is a portable diagnostor of the CAN communication interface, and the detecting unit 21 is electrically connected with the second circuitry 4, and is used to transfer the second signal of the ISO11898 communication protocol. With the above design, signal transmission can be performed between the detecting unit 21 of the CAN communication interface and the ECU 22 of the K-Line communication interface, which also can reduce the acquisition cost for acquiring additional communication interface.

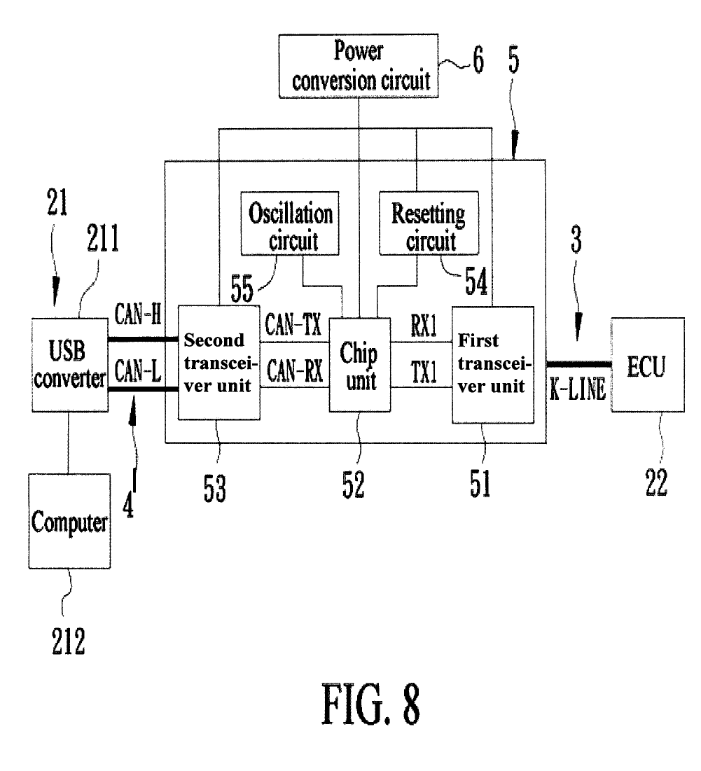

FIG. 8 is a fourth preferred embodiment of the communication interface conversion device according to the present invention. The fourth preferred embodiment is substantially the same as the third preferred embodiment, and differences lie in that, the detecting unit 21 has a USB converter 211 of a CAN interface and a computer 212 electrically connected with the USB converter 211. The USB converter 211 is electrically connected with the second circuitry 4, and is used to transfer the second signal of the ISO11898 communication protocol. With the externally connected USB converter 211, the signal can be transferred and received between the computer 212 and the ECU 22.

In view of the above, the first signal of the ECU 22 and the second signal of the detecting unit 21 may be converted into each other by using the first transceiver unit 51, the chip unit 52, and the second transceiver unit 53 of the conversion module 5, so that the ECU 22 and the detecting unit 21 of different interfaces may perform signal transmission. Thus, the generality is improved, and the acquisition cost can be effectively reduced by avoiding additionally equipping with different detecting units. Therefore, the objective of the present invention is achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A communication interface conversion device, suitable for electrically connecting a detecting unit and a vehicle electronic control unit (ECU) with different interfaces, wherein the communication interface conversion device comprises:
a first circuitry, electrically connected with the vehicle ECU, used to transfer a first signal of the ECU;
a second circuitry, electrically connected with the detecting unit, used to transfer a second signal of the detecting unit; and
a conversion module, comprising a first transceiver unit electrically connected with the first circuitry, a chip unit electrically connected with the first transceiver unit, a resetting circuit that is electrically connected with the chip unit and enables the chip unit to be reset, an oscillation circuit electrically connected with the chip unit, and a second transceiver unit electrically connected with the chip unit, wherein the oscillation circuit is capable of transferring a reference frequency to the chip unit, so as to stabilize an operating frequency of the chip unit, and the first signal and the second signal is converted into each other by using the first transceiver unit, the second transceiver unit, and the chip unit.

2. The communication interface conversion device according to claim 1, wherein the first circuitry is a controller area network (CAN) communication interface, and the second circuitry is a K-Line communication interface.

3. The communication interface conversion device according to claim 2, wherein the first signal complies with an ISO11898 communication protocol, the first transceiver unit performs electronic signal conversion on the first signal, so as to enable the chip unit to interpret the first signal, the second signal complies with an ISO14230 communication protocol, the second transceiver unit performs electronic signal conversion on the second signal, so as to enable the chip unit to interpret the second signal, so that the chip unit converts the first signal of the ISO11898 communication protocol and the second signal of the ISO14230 communication protocol into each other.

4. The communication interface conversion device according to claim 3, wherein the detecting unit is a diagnostor of a K-line interface, the diagnostor is electrically connected with the second circuitry, and is used to transfer the second signal of the ISO14230 communication protocol.

5. The communication interface conversion device according to claim 3, wherein the detecting unit has a universal serial bus (USB) converter of a K-line interface, and a computer electrically connected with the USB converter, and the USB converter is electrically connected with the second circuitry, and is used to transfer the second signal of the ISO14230 communication protocol.

6. The communication interface conversion device according to claim 1, wherein the first circuitry is a K-Line communication interface, and the second circuitry is a CAN communication interface.

7. The communication interface conversion device according to claim 2, wherein the first signal complies with an ISO14230 communication protocol, the first transceiver unit performs electronic signal conversion on the first signal, so as to enable the chip unit to interpret the first signal, the second signal complies an ISO11898 communication protocol, and the second transceiver unit performs electronic signal conversion on the second signal, so as to enable the chip unit to interpret the second signal, so that the chip unit converts the first signal of the ISO14230 communication protocol and the second signal of the ISO11898 communication protocol into each other.

8. The communication interface conversion device according to claim 7, wherein the detecting unit is a diagnostor of a CAN interface, the diagnostor is electrically connected with the second circuitry, and is used to transfer the second signal of the ISO11898 communication protocol.

9. The communication interface conversion device according to claim 7, wherein the detecting unit has a USB converter of a CAN interface, and a computer electrically connected with the USB converter, the USB converter is electrically connected with the second circuitry, and is used to transfer the second signal of the ISO11898 communication protocol.

10. A signal conversion method of a communication interface conversion device, comprising:
an instruction setting step, in which a detecting unit sets a transfer instruction, transfers a second signal to a second transceiver unit of a conversion module via a second circuitry;
a first conversion step, in which the second transceiver unit of the conversion module performs electronic signal conversion on the received second signal, and transfers the second signal to a chip unit;
a transferred data conversion step, in which the chip unit of the conversion module converts the received second signal into relay data, sets a frequency and a sampling rate of the relay data, converts the transfer instruction into a reception instruction readable to an electronic control unit (ECU), so as to convert the relay data into a first signal, and transfer the first signal to the first transceiver unit;
a second conversion step, in which the first transceiver unit of the conversion module performs electronic signal conversion on the received first signal, and transfers the first signal to the ECU;
a reply processing step, in which the ECU receives the first signal and reads the transfer instruction, and then replies with another first signal to the first transceiver unit via a first circuitry;
a third conversion step, in which the first transceiver unit of the conversion module performs electronic signal conversion on the received first signal, and transfers the first signal to the chip unit;
a received data conversion step, in which the chip unit converts the received first signal into relay data, and compares the frequency and the sampling rate of the relay data, so as to convert the relay data into a second signal and transfer the second signal to the second transceiver unit; and
a fourth conversion step, in which the second transceiver unit of the conversion module performs electronic signal conversion on the received second signal, and transfers the second signal to the detecting unit.

11. The signal conversion method of the communication interface conversion device according to claim 10, wherein the first circuitry is a controller area network (CAN) communication interface, and the second circuitry is a K-Line communication interface.

12. The signal conversion method of the communication interface conversion device according to claim 11, wherein the first signal complies with an ISO11898 communication protocol, the second signal complies with an ISO14230 communication protocol, and the relay data complies with an ISO15765 communication protocol.
